(19) United States
(12) Patent Application Publication
(10) Pub. No.: US 2012/0091666 A1
(43) Pub. Date: Apr. 19, 2012

(54) BRAKE CALIPER SEAL GROOVE

(75) Inventors: Galus Chelaidite, South Lyon, MI (US); Gang Lou, Rochester, MI (US)

(73) Assignee: AKEBONO CORPORATION, Elizabethtown, KY (US)

(21) Appl. No.: 12/906,470

(22) Filed: Oct. 18, 2010

(51) Int. Cl. F16J 15/16; F16D 65/20; B26D 3/06

(52) U.S. Cl. 277/587; 83/875

(57) ABSTRACT

A seal groove comprising: a back wall; a front wall opposed to the back wall; a bottom wall connected to the front wall and the back wall; and a recess in the front wall connecting the front wall to the piston bore; wherein the recess includes a peak which comprises: a first angled portion and a second angled portion.

### FIELD OF THE INVENTION

The present invention generally relates to seals, seal grooves, pistons, and more particularly to an angled wall of the seal groove and a pre-cut or a cutable seal that is especially suited for use in a brake assembly.

### BACKGROUND OF THE INVENTION

Typical disc brake systems involve a caliper which, during brake apply, develops a clamping force against brake pads in the wheel axial direction onto an annular braking path on the rotor. The clamping force is created during a brake apply by increasing fluid pressure in the piston bore of the caliper body, which forces the piston towards the rotor. Brake fluid leakage is prevented by a seal installed between the caliper body and the piston. The seal is located inside a groove (i.e. the annular seal groove) that is machined into the piston bore of the caliper body. The seal, seal groove, and piston dimensions are such that when the piston is inserted into the bore, an interference fit between the seal, which deforms against the piston's outer diameter and the bottom of the seal groove, prevents fluid leakage or substantially prevents fluid leakage. Additionally, upon brake release, the seal retracts the piston to preferably the same position as before the brake apply. The retraction is performed independent of the pressure experienced by the piston during the brake apply. However, if the piston retraction is too small, the piston remains in contact with the brake pad which in turn remains in contact with the rotor. A small brake drag is, therefore, maintained which results in increased fuel consumption and reduced brake pad and rotor life, or both. If the piston retraction is too large, a large air gap is created between the piston and the brake pad, thus resulting in a longer brake pedal travel. The longer brake pedal travel will result in a poor pedal feel and possibly even customer complaints.

For many years, industry has been concerned with the design of braking systems for use with automotive vehicles or other modes of transportation. More recently, reduced fuel consumption has become an increasingly important challenge among vehicle manufacturers and vehicle owners. One factor that affects fuel consumption is brake drag caused by contact forces between one or more brake pads and the vehicle's rotor due to insufficient piston retraction distance. Examples of modifications to the caliper by adapting the seal groove in an attempt to improve piston retraction are disclosed in U.S. Pat. Nos. 4,387,901; 5,076,593; 5,325,940; 6,244,393; and 7,191,875, and U.S. Application Publication No. 2009/0272606, all of which are expressly incorporated by reference herein for all purposes.

One challenge faced by brakes is providing a brake where, after a brake apply, the piston returns to its pre-brake position regardless of the brake pressure applied during braking. Historically, the shape of the seal groove included substantially flat walls or a chamfer in one of the walls, creating additional space for the seal to move into and maintain contact with the piston as the piston travels in the apply direction. Attempts have been made to vary the size and shape of the chamfers in the wall so that piston retraction distance is better controlled and maintained independent of the pressure experienced during a brake apply.

Another challenge faced by brakes is how to optimize the air gap (i.e. running clearance). For example, a large air gap causes the brake to feel soft; whereas, a small air gap may cause an increased drag torque. Thus, ideally, the air gap will be small enough that a normal brake feel is maintained, but large enough so that drag torque is minimized. The air gap may vary due to, or be controlled by some of the following factors: rotor lateral run out (LRO); steady state pad taper and cupping; caliper deflection; pad compressibility; seal material hardness, shape, design, size, placement of the front wall, the shape of the front wall, or a combination thereof. For example, a larger LRO, larger pad taper and cupping, or a combination thereof will increase brake drag, thus, a larger air gap will be required. In another example, increased caliper deflection and pad compressibility may cause the piston to travel further during a brake apply; thus, upon brake release, the piston retraction distance is increased if the piston is to return to the same position prior to the brake apply. Generally, the seal moves along with the piston as the piston travels towards the front wall of the seal groove in the apply direction. When braking pressure is removed the piston is moved back into the bore by the deflected caliper, the compressed brake pads, the deflected seal, or a combination thereof. If the piston slips with respect to the seal at any time during the brake apply, then upon brake release, the piston will retract less(e.g. by about the slip distance).

Another challenge faced is deterioration of the seal with repeated use, thus, affecting piston retraction. After multiple brake applies at different pressures, the seal will become “chewed” up or ripped up (i.e., “seal nibble”) especially at locations that contact chamfers in the seal groove. For example, the greater the angle between the front wall and the chamfer (i.e., a sharper corner) the greater nibble the seal will experience. Ideally, seal nibble should be minimized, and some attempts to minimize seal nibble may be found in U.S. Pat. Nos. 5,325,940 and 6,244,393. Therefore, an object of the present invention is to provide a caliper assembly with an improved seal groove, seal, or both that will assist in piston retraction so that fuel consumption can be reduced without causing a soft brake pedal feel. In addition, this will result in improved brake pad life, rotor life, seal life, or a combination thereof.

### SUMMARY OF THE INVENTION

One possible embodiment of the present invention includes a back wall; a front wall opposed to the back wall; a bottom wall connected to the front wall and the back wall; and a recess in the front wall connecting the front wall to the piston bore; wherein the recess includes a peak which comprises: a first angled portion and a second angled portion. The seal groove may include at least one angled portion in the forward wall. The piston bore may further include at least one angled portion that forms a peak that has a first edge and a second edge. The first edge may have a positive slope, and the second edge may have a negative slope, wherein upon applying a first braking pressure the piston travels substantially axially toward the forward wall forcing the seal into contact with the peak on the forward wall, cutting the seal. The first angled portion may be the front wall.

Another possible embodiment may be a method of cutting a seal by obtaining a seal; cutting the seal with a peak, wherein the piston bore includes a seal groove and a seal, wherein the seal groove includes a peak and the piston forces the seal into contact with the peak so that the peak cuts the seal. The seal may be cut before the seal is placed in the seal groove. However, in another embodiment the seal may be cut by a peak including a first edge having a positive slope, and a second edge having a negative slope. When a braking force is applied the piston may travel substantially in the axial direction toward the forward wall forcing the seal into contact with the peak, cutting the seal. The first edge and the second edge may form an angle between about 15 and about 110 degrees. Preferably, the first edge and the second edge may form an angle between about 30 and about 60 degrees.

One unique aspect of the present invention envisions a seal groove and/or seal that allows a constant air gap to be maintained. A constant air gap is when the piston starts at a first position, then after a brake apply and brake release cycle is complete the piston returns substantially back to the first position regardless of the amount of pressure experienced during the brake apply. The present invention may maintain a small air gap by employing one or more of the present design improvements. For example, the brake system may include a precut seal, a cutable seal, the brake system may cut the seal, the brake system may employ a peak (i.e. a pivot point), or a combination thereof. It is envisioned that the present invention may employ one or more of the improvements discussed herein.

Accordingly, the present inventors have identified that by using a seal, which includes a cut, the piston will readily and consistently return to its pre-brake position. The seal may assist to retract the piston back to substantially the same position after every brake apply. The present inventors have further identified that this may be accomplished by either a precut seal or by cutting the seal once the seal has been placed in the seal groove. The cut in the seal may allow for a constant and consistent piston retraction. The cut in the seal may assist the rest of the seal to maintain contact with the piston (i.e. a portion of the seal inner diameter (i.e., the cut portion), which normally is in contact with the outer diameter of the piston, will not separate from the piston) at any applied pressure. It is further believed that the cut in the seal will reduce seal nibble by creating a clean cut in the seal so that the seal is not repeatedly damaged during brake applies.

The present inventors have further identified that by using a seal groove that includes a peak, piston retraction is improved. The present inventors have identified that by forming a sharp peak, an uncut seal, while pivoting around the peak during an initial brake apply, will be cut such that on subsequent brake applies, the seal will maintain contact with the piston so that piston slip is reduced, does not occur, or both. The present inventors have identified a method and structure for a seal and/or seal groove that allows for tight air gap tolerances so that air gap is minimized, drag torque is minimized, fluid displacement during brake apply is minimized, or a combination thereof; thus, resulting in overall good pedal feel and/or reduced fuel consumption. It is believed that the present invention will allow for a constant air gap to be maintained.

### BRIEF DESCRIPTION OF THE DRAWINGS

FIG. 1 shows a perspective view of a cross section of a brake system;

FIG. 2 shows a view of one embodiment of the present invention;

FIG. 3 shows a cross sectional view of one embodiment of the present invention after a brake apply;

FIG. 4 shows a cross sectional view of another view of one embodiment of the present invention before the brake is applied;

FIG. 5 shows a cross sectional view of another embodiment of the present invention with a pre-cut seal;

FIG. 6 shows a cross sectional view of one embodiment of the present invention;

FIG. 7 shows a cross sectional view of another possible embodiment of the present invention; and

FIG. 8 shows a cross sectional view of one possible embodiment of the present invention.

### DETAILED DESCRIPTION OF THE INVENTION

The following description of the preferred embodirnent(s) is merely exemplary in nature and is in no way intended to limit the invention, its application, or uses.

The present invention is predicated upon providing an improved disc brake system and caliper for use with vehicles. For example, the caliper may be used with almost any vehicle (e.g. car, truck, bus, train, airplane, or the like). Alternatively, the caliper may be integrated into assemblies used for manufacturing or other equipment that require a brake such as a lathe, winder for paper products or cloth, amusement park rides, or the like. However, the present invention is most suitable for use with a passenger vehicle (i.e. a car, truck, sports utility vehicle, or the like).

Generally, a braking system includes a rotor, a caliper body, a support bracket, an inboard brake pad, and an outboard brake pad that are on opposing sides of the rotor. The caliper body further includes a bridge, one or more fingers, and a .piston bore. The piston bore houses a piston. The piston bore may include a fluid inlet, a closed wall, a front opening, and a cylindrical side wall that includes an annular groove (i.e. seal groove) located near the front opening. Typically, the fluid inlet is located in the closed wall of the piston bore so that when pressure is applied the fluid will flow into the piston bore. During a pressure apply the fluid will push the piston towards the front opening and into contact with a brake pad. However, during a pressure apply the piston may be pushed by a mechanical force instead of a fluid pressure. For example, during a brake apply, a mechanical actuator may push the piston into contact with the brake shoe. Preferably, the piston is pushed by a fluid. More preferably, the piston is pushed by brake fluid.

The annular groove may include a seal. The seal may have a height, circumference (e.g., length), and a width. The height of the seal may be tall enough so that upon inserting the piston into the bore, an interference fit between the piston and the seal is created so that fluid leakage out of the front opening is prevented. The height of the seal may be tall enough such that the seal extends out of the annular groove so that the seal contacts the piston and forms an interference fit. The height of the seal may be a function of circumference (e.g. the outer circumference minus the inner circumference). The inner circumference of the seal may be small enough so that the seal contacts the piston so that fluid cannot move past the seal.

The width of the seal may be smaller than the annular groove (i.e. distance between the front wall and the back wall of the annular groove). Preferably, the seal will be wide enough so that fluid leakage is prevented. More preferably, prior to piston insertion, the seal width will be smaller than the groove width, and after piston insertion, the width of the seal may increase but still be smaller than the width of the seal groove so that the seal may have room to swell as the temperature of the braking system increases due to use. However, the width of the seal even at high temperatures may be smaller than the groove width. The width of an installed seal may be about 5 mm or less, preferably about 4 mm or less, or more preferably about 3.5 mm or less. The width of an installed seal may be about 1 mm or more, preferably about 2 mm or more, or more preferably about 2.5 mm or more (e.g. between about 3 mm to about 3.3 mm).

The seal may be made of any material that is resistant to brake fluid. The seal may be made of any material that is stable over a wide temperature range. The seal may be made of any material that is not easily affected by piston slip. The seal may be made of any material that does not degrade. For example, the seal may be made of any material that does begin to fall apart from repeated contact with the front wall (i.e. nibbled away). The seal may be made of a polymeric material. Preferably, the seal may be made of an elastomeric material. More preferably, the seal may be made of: rubber (e.g. Ethylene Propylene Diene Monomer (EPDM)). The seal may be made of a resilient material so that the seal continues to resist fluid leakage after repeated brake applies (e.g. about 1,000 brake applies or more, about 10,000, brake applies or more, about 100,000 Wake applies or more, or even about 1,000,000 brake applies or more). Preferably, the seal will be made of a material that allows the seal to be cut and the ability of the seal to resist fluid leakage is not reduced (i.e. the seal is just as effective at resisting fluid in the cut state as it is in the non-cut state).

The seal may be cut to a depth. The depth of the cut may be deep enough so that the cut seal assists in retracting the piston, but no so deep that the cut causes the seal to fail and/or tear. Preferably, the depth of the cut may be deep enough so that when the piston travels in the apply direction the seal may travel around the pivot point and maintain contact with the piston. The depth of the cut may vary depending on the amount of pressure applied to the piston during a pressure apply. The depth of the cut may vary based upon the stiffness of the caliper assembly. The depth of the cut may vary based upon the amount the caliper deflects during a brake apply. The depth of the cut may vary based upon the amount the pads compress during a brake apply. For example, a high stiffness caliper may have a shallow cut and a low stiffness caliper may have a deep cut. The depth of the first cut may determine the depth of the cut (i.e. subsequent brake applies will not deepen the cut). For example, a high pressure load may be applied so that a deep cut is made during an initial brake apply. A pressure apply of about 20 MPa or less, about 18 MPa, or less, about 15 MPa or less, or even about 12 MPa or less may create a deep cut in the seal so that subsequent cuts will not make the cut deeper. The depth of a cut may be about 1.5 mm or less, preferably about 1.3 mm or less, or more preferably about 1.1 mm or less. The depth of a cut may be about 0.2 mm or more, preferably about 0.5 mm or more, or more preferably about 0.8 mm or more (e.g. about 1 mm deep).

The depth of the cut may vary from caliper to caliper. The depth of the cut may vary based upon the location of the peak. The depth of the cut may vary based upon the angle of the peak. The depth of the cut may vary based upon the angle of the peak relative to the front wall, also referred to as the attitude of the peak. For example, a smaller angle may cut deeper into the seal or vice versa. The depth of the cut may vary based upon the attitude of the peak. Preferably, the depth of the cut may not vary based upon the attitude of the peak (i.e. the direction the peak faces). The peak may be moved axially, in relation to the rotor, towards the front wall or axially away from the front wall. For example, if the peak is moved axially, in relation to the rotor, closer to the front wall the depth of the cut may be deeper. If the peak is moved axially, in relation to the rotor, further from the front wall the depth of the cut may be reduced. The peak may be located a distance from the front wall. For example, the larger the distance the peak is located from the front wall the smaller the depth of the cut may be at the same pressure apply. In another example, the shorter the distance the peak is located from the front wall the larger the depth of the cut may be. The peak may be substantially aligned with the front wall (e.g., the distance is effectively zero). The distance the peak may be located from the front wall is about 1 mm or less, preferably about 0.8 mm or less, or more preferably about 0.6 mm or less. The distance the peak may be located from the front wall is about 0 mm, about 0.1 mm or more, or about 0.2 mm or more (e.g. between about 0 mm to about 0.6 mm).

The shape of the cut may be any shape that the peak cuts into the seal during a pressure apply. The shape of a cut in a pre-cut seal may be the same shape as a cut created by the peak. The shape of a cut in a pre-cut seal may differ from that of a cut created by a peak. The shape of the cut may be straight, arcuate, straight then arcuate, curve up, curve down: zigzag, or a combination thereof when viewed as a cross section. Preferably, the cut may slice the seal without removing material. The cut may be generally circular in shape, generally oval in shape, generally triangular in shape, a combination thereof, or the like, when viewed as a cross section. However, it is contemplated that a cut in the seal may remove material. For example, a “V,” a generally circle shape, a curved shape, or a combination thereof may be cut into the seal and material may be removed. A corner of the seal may be removed so that the remaining area of the seal may include a generally concave and/or convex shape that may be arcuate, straight, curved, circular, or a combination thereof. The portion of the seal removed may be removed from an edge that faces a wall. The seal may be free of a removed portion where the removed portion only contacts the piston (i.e. a central portion of the seal may not have any material removed). The seal may have one or more removed portions. Preferably, the seal only includes one removed portion. For example, a cut may not remove material and then at the deepest portion of the cut have a piece of material removed (i.e., square, circular, oval, triangular, the like, or a combination thereof). Preferably, material will not be removed when a cut is made in the seal while the seal is within the annular groove. A seal that has material removed may be used with an annular groove that includes a peak. Preferably, a seal that has material removed may not be used with an annular groove that includes a peak. Once the seal is cut the seal may appear as if no cut exists in the seal (i.e. the two portions may overlap so that the cut is not readily apparent).

In one embodiment, the seal may be cut before (i.e. precut seal) and placed in the seal groove. The seal may be cut in a predetermined location along its width and height (i.e. any of the cut locations discussed herein). The seal may be cut and placed in any seal groove. The seal may be placed in a new brake or an old brake (e.g. a rebuilt brake). The precut seal may be used with a seal groove that includes a peak. The precut seal may be used with a seal groove that does not include a peak. The seal may be cut by any method that may cut a seal; for example, the seal may be cut by a machine, by hand, by a laser, by any of the configurations discussed herein, or a combination thereof.

The annular groove may include a front wall, a back wall, and a bottom. The annular groove may have a width. The width of the annular groove is the distance from the front wall to the back wall. The annular groove may have a height. The height of the annular groove may be the distance from the bottom of the annular groove to the bore. The annular groove may include more than one height. One side of the annular groove may have a first height and the other side of the annular groove may have a second height (i.e. the angle of the bottom of the annular groove is different at the front wall than the back wall). The front wall may be located in the apply direction of the piston (i.e. axially closer to the front opening in the piston bore than the back wall). The back wall may be located in the retract direction of the piston (i.e. between the closed wall of the piston bore and the front wall). The piston may travel substantially axially towards the rotor (i.e. apply direction) during a brake apply. During a brake apply, fluid pressure increases behind the piston which forces the piston to move axially into contact with a brake pad, while the seal prevents fluid leakage. During a brake apply, the piston and the fluid pressure may pull and/or push the seal towards and/or against the front wall as the piston travels into contact with the brake pad. The brake pads are pushed into contact with the rotor by the piston and the caliper fingers, thus, creating a braking force. When the brake is released, the piston may travel substantially back (i.e. retract direction) to its pre-brake position: The position of the piston before and after a brake apply may be measured and may create an air gap (i.e. running clearance).

Air gap may be the total distance between the face of the inboard brake pad and the face of the outboard brake pad minus the thickness of the rotor, when the inboard brake pad contacts the piston and the outboard brake pad contacts the fingers. To state it another way, air gap may be the distance between the face of the rotor on the outboard side and the face of the outboard brake pad when the inboard brake pad is pushed into contact with the face of the rotor on the inboard side and when the inboard brake pad contacts the piston and the outboard brake pad contacts the fingers. The air gap may be any size that allows for braking. The air gap may be any size that does not give the brake pedal a soft feel. The present invention may allow for a constant air gap of about 0.5 mm or less, preferably about 0.4 mm or less, or more preferably about 0.3 mm or less to be maintained. The present invention may allow for a constant air gap of about 0.005 mm or more, about 0.02 mm or more, preferably about 0.05 mm or more, more preferably about 0.1 mm or more, or even more preferably about 0.15 mm or more (e.g, between about 0.05 to about 0.3 mm).

The seal assists in retracting the piston. For example, upon brake release, the piston will be forced back by the deflected caliper body and pads, but the piston will be further retracted by the seal. During a brake apply the fluid pressure and the piston may pull and/or push the seal forward toward and/or against the front wall of the annular groove. The seal may contact all or a portion of the front wall of the annular groove. When the brake apply is complete the seal may assists in pulling and/or pushing the piston back to its pre-apply position so that an air gap is created. However, the seal and/or piston may slip as the seal is being pulled and/or pushed by the piston and fluid pressure during the brake apply. This slip may reduce the distance that the piston is retracted by the seal upon brake release. The inventors of the present invention have created a cut seal and/or a cutable seal that minimizes piston slip. Thus, the present invention advantageously assists in retracting the piston to maintain a constant and repeatable air gap distance regardless of the fluid pressure experienced by the caliper during the prior brake apply.

The present inventors have identified that the seal may be pre-cut and then placed in an annular groove. The cut may also be made after the piston is placed in the annular groove and the brake is applied initially, preferably after the caliper is assembled in the plant. The cut may be located at any location in the seal. Preferably, the cut in the seal may be made at a location that assists in retracting the piston and maintains the sealing function. Preferably, the cut may be in the side of the seal that comes into contact with the front wall. The cut may have a depth. Preferably, the depth of the cut will be constant across the profile of the seal. The depth of the cut may vary across the profile of the seal. The cut may be located anywhere along the height of the seal. The cut may be located in the top half of the seal. Preferably, the cut will be located in the top quarter of the seal.

The seal may assist in retracting the piston. The cut may allow the seal (i.e. the uncut portion of the seal) to maintain contact with the piston along the remaining uncut portion of the width of the seal. Preferably, the cut may allow the seal to maintain contact (i.e. an interference fit) with the piston along the entire uncut width of the seal. The cut in the seal may allow the cut portion of the seal to pivot around the peak in the front wall and not interfere with the piston movement during the brake apply. Preferably, the cut may allow the cut portion of the seal to enter the expansion chamber behind the peak in the front wall and allow the piston to move unrestricted towards the rotor during a brake apply. The cut may maintain piston slip constant relative to non-cut seals. Preferably, the cut may decrease piston slip. More preferably, the cut may eliminate piston slip during normal pressure applies, but allow for piston slip at very low pressures to adjust for pad wear.

The seal may be cut by any method capable of cutting the seal, and which facilitates the advantages of the invention discussed herein. The seal may be cut by a machine. The seal may be cut by hand. The seal may be created with the cut already in the seal. It is contemplated that the seal may be cut by different methods. These methods may be performed when the seal is created, after the seal is created, prior to seal installation into the seal groove, after the seal is placed in the seal groove, or a combination thereof. The seal may be cut before or after the seal is placed in the seal groove. The seal may cut by any of the methods discussed herein. A seal may be obtained. The seal may be placed in a device for cutting a seal (e.g. a machine with a knife, a sharp ring, the seal groove discussed herein, a user's hand, a laser, or the like). Preferably, the seal may be cut with a sharp edge. The seal may be placed into the seal groove before cutting or after cutting. The seal may be cut by any structure discussed herein. The seal may be cut when a brake pressure is applied. Preferably, the first pressure apply after a non-cut seal is installed in the annular groove may be a maximum pressure brake apply so that the seal is cut to its maximum depth. The seal may be moved into contact with a peak in the seal groove. The seal may be pulled and/or pushed into contact with the peak in the seal groove by the piston and/or by the fluid pressure during a brake apply.

The present inventors have also identified that the seal may be cut by the structure of the piston bore. The annular groove in the piston bore may include one or more features that allow the seal to be cut. For example, the front wall of the annular groove may include a recess with a peak (i.e. pivot point) located within the recess that cuts the seal as the piston moves in the apply direction during a brake apply. The peak may be created by one or more angled portions being created in the front wall. The one or more angled portions may be created when the annular groove is cast, machined, or the like.

The peak includes a property referred to as attitude (i.e. the direction the peak points relative to the front wall). The attitude of the peak may point in the apply direction. The attitude of the peak may point in the retract direction so that as the piston moves in the apply direction the seal is pushed into the peak. The attitude of the peak may be pointed in a substantially neutral direction (i.e. does not point towards either the apply direction or the retract direction). The attitude may be represented by a line that bisects the angle between the two lines that form the peak and passes through the peak. For example, if the angle between the two lines that form peak is 60 degrees the angle between the attitude line and the two lines that form the peak will each be 30 degrees. The angle of the attitude line with respect to the front wall represents the attitude of the peak. The attitude may be a positive slope. The attitude may be a negative slope. The attitude may be neutral (i.e. the attitude line may be perpendicular to the piston bore axes).

The peak may be formed at any angle that is capable of cutting the seal and is capable of being manufactured. Preferably, the angle of the peak may be an angle that does not damage the seal upon repeated contact with the peak. The peak may cut the seal upon an initial brake apply to a depth. The attitude of the peak may be parallel to the cylindrical wall of the piston bore (i.e. parallel to the piston travel). Preferably, the attitude of the peak may be substantially perpendicular to the cylindrical wall of the piston bore (i.e. perpendicular to the piston travel). More preferably, the attitude of the peak may be any angle between parallel and perpendicular to the cylindrical wall of the piston bore (e.g. between about 45 degrees and about −45 degrees measured from a line perpendicular to the piston bore axis).

The peak may include a first angled wall. The cross-sectional angle of the first wall may be any angle capable of forming a peak. The first angled wall portion may have a positive slope. The first angled wall may have a negative slope. For example, depending on the orientation of a cross section of the annular groove the slope may be positive and then when viewed from the other side of the cross section the slope may be negative. The rise of the first angled wall and the run of the first angled wall may both be positive or both be negative (i.e. a positive slope). The first angled portion may be an extension of the front wall (i.e. the front wall and the first angled portion are the same angle). The first angled portion may have about a zero degree angle when measured relative to the front wall (i.e. the front wall is the first angled portion). The first angled wall may have an angle of less than about 90 degrees when measured from the front wall of the annular groove. Preferably, the first angled wall may have an angle of less than about 70 degrees when measured from the front wall of the annular groove. More preferably, the first angled wall may have an angle of less than about 50 degrees when measured from the front wall of the annular groove.

The peak may include a second angled wall. The cross-sectional angle of the second wall may be any angle capable of forming a peak. The second angled wall portion may have a negative slope. The second angled portion may have a positive slope. The rise of the first angled wall and the run of the second angled wall may different (i.e. one positive and one negative). Preferably, if the slope of the first angled wall is positive the second angled wall will be negative or vice versa. For example, the second angled wall may rise towards the piston, but run in the retract direction. The second angled wall may have an angle of less than about 90 degrees when measured from the front wall of the annular groove. Preferably, the second angled wall may have an angle of less than about 75 degrees when measured from the front wall of the annular groove. More preferably, the second angled wall may have an angle of less than about 65 degrees when measured from the front wall of the annular groove.

The first angled wall and the second angled wall may form an angle between them. The angle formed between the first angled wall_{.} and the second angled wall may be any angle capable of forming a peak that may cut the seal. The peak may be any angle that forms a sharp edge (i.e. has enough material thickness) so that the peak cuts the seal. The peak may be any angle that is rigid enough that it will not fracture, break, or become damaged from repeated contact with the seal during brake applies. Preferably, the angle of the peak may have enough material so that the peak cuts the seal and does not deform during multiple uses. The peak may be any angle that is sufficiently steep so that the seal is easily and smoothly cut. Preferably, the peak may be an angle that is sharp so that the peak does not nibble away at the seal during repeated use. The angle formed between the first angled wall and the second angled wall may be about 140 degrees or less. Preferably, the angle between the first angled wall and second angled wall may be about 110 degrees or less. More preferably, the angle between the first angled wall and the second angled wall may be about 95 degrees or less.

The first angled wall and the second angled wall may form a blunt peak (i.e. point that does not form a. sharp angle). The blunt peak may cut the seal. The blunt peak may create a clean cut in the seal. The blunt peak may reduce and/or eliminate seal nibble. The blunt peak may include a blunt wall that connects the first angled wall to the second angled wall. The blunt wall may be about 0.1 mm or less, about 0.05 mm or less, or about 0.005 mm or less in length. The blunt wall may be any length that cuts the seal. The blunt wall may be at any orientation that allows the blunt peak to cut a seal. The blunt wall may form a flat surface; for example, the first wall and the second wall may connect to the blunt wall at the same height so that it is substantially perpendicular to the seal. The blunt wall may form an angled surface; for example, the first wall and the second wall may connect to the blunt wall at different heights so that the blunt wall forms an angle relative to the seal. The, blunt wall may form any angle that allows the blunt peak to cut the seal. The blunt wall may form about a 45 degree angle or more, preferably about a 60 degree angle or more, or more preferably about a 90 degree angle relative to the front wall. The blunt wall may form about a 150 degree angle or less, about a 135 degree angle or less, preferably about a 110 degree angle or less relative to the front wall.

The annular groove may include an expansion chamber within the recess. The expansion chamber may be located axially past the peak in the apply direction (i.e. closer to the rotor than the peak). The expansion chamber may be any portion of material that has been removed so that a peak may be formed. The expansion chamber may be located between the second angle of the peak and a third angle. The expansion chamber may be any shape that is capable of defining a peak. The expansion chamber may be a rounded portion that is made in the piston bore so that a peak may be formed. The expansion chamber may have a radius of about 1.0 mm or less. Preferably, the radius of the expansion chamber may be about 0.5 mm or less. More preferably, the radius of the expansion chamber may be about 0.3 mm or less. The expansion chamber may have a radius of about 1.0 mm to about 0.1 mm. Preferably, the expansion chamber may have a radius of about 0.8 to about 0.2 mm. More preferably, the expansion chamber may have a radius of about 0.4 mm to about 0.3 mm. The expansion chamber may be an angled portion that is made in the piston bore so that a peak may be formed. The expansion chamber may allow the cut portion of the seal to enter past the peak when the seal moves in the apply direction. The piston bore may not include a expansion chamber. For example, the two portions of the cut seal will split so that a portion of the seal is on each side of the peak and the cut portion enters the expansion chamber.

The annular groove may include a shelf. An annular groove that includes a shelf may not include a expansion chamber. The annular groove may include both a shelf and a expansion chamber. The shelf may be formed axially on the apply side of the peak. The shelf maybe in contact with the third angled portion. The shelf may be substantially concentric to the piston bore. The shelf may be substantially perpendicular to the front wall of the annular groove. The shelf may be used in place of the second angled portion (i.e. the shelf may be the second angled portion). When the annular groove includes a shelf the annular groove may be free of a expansion chamber.

The third angled portion may be any angle capable of creating an expansion chamber. The third angled portion may be any angle capable of creating a shelf. The third angled portion may have a positive slope. The third angled portion may have a negative slope. Preferably, the third angled portion and the first angled portion slope in the same direction (i.e., both positive or both negative). The rise of the third angled portion and the run of the third angled portion may both be positive or both be negative. For example, the third angled portion may begin touching the expansion chamber of the annular groove and then as the third angled wall travels towards the piston the wall runs in the apply direction. This angled portion may be perpendicular to the bore or angled so that the angled portion ends at the bore, and the corner on the bore is closer to the rotor than the corner at the start of this angled portion in the expansion chamber or shelf portion.

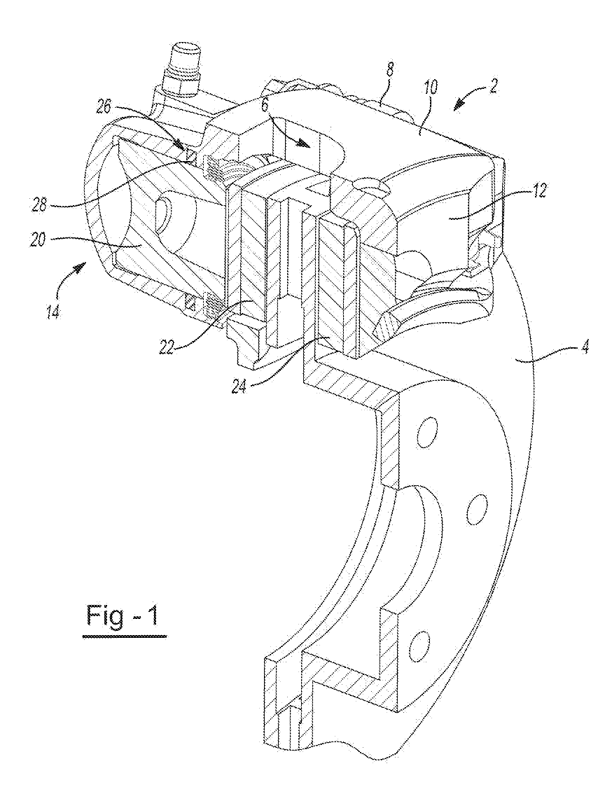

As is illustrated in FIG. 1, the brake system 2 includes a rotor 4, a caliper body 6, and a support bracket 8. The caliper body 6 is comprised of: a bridge 10, at least one finger 12, and at least one piston bore 14. The caliper body includes at least one piston 20 located in the at least one piston bore, at least one inboard brake pad 22, at least one outboard brake pad 24, an annular seal groove 26, and a seal 28 located in the annular seal groove.

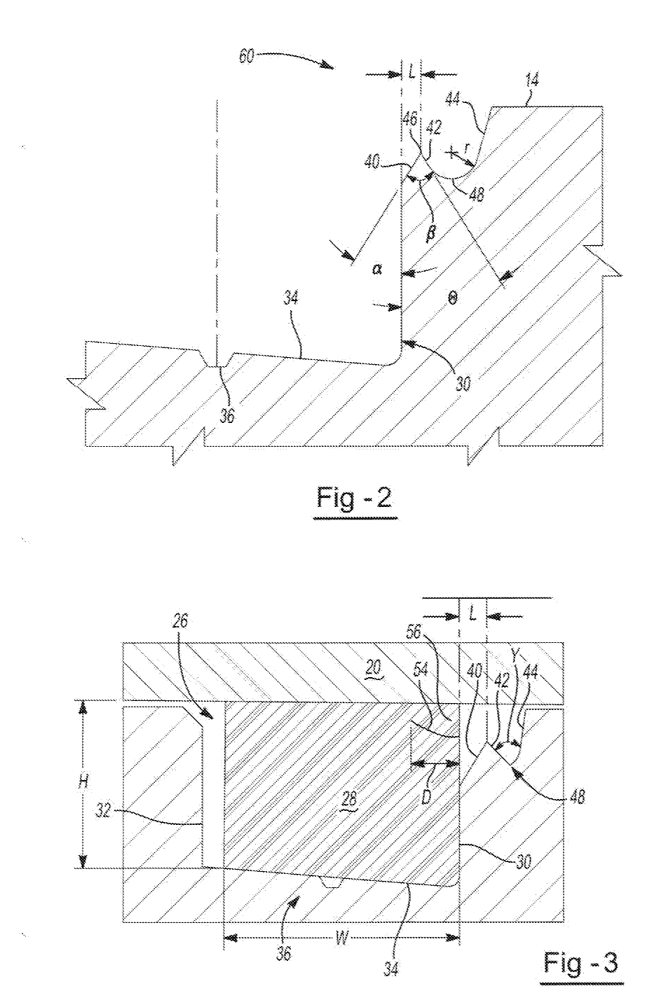

As can be seen in FIGS. 2-7 the annular seal groove 26 may include a front wall 30, a back wall 32, a bottom 34, a recess 36 in the bottom 34, and a recess 60 in the front wall 30. The front wall 30, back wall 32, or both may be flat, contoured, chamfered, angled, or a combination thereof. Preferably, the front wall 32 will include most of the contours, chamfers, angles, or a combination thereof, and the back will be substantially flat. However, the back wall may include one or more contours, chamfers, angles, or a combination thereof.

With reference to one embodiment shown in FIG. 2 the front wall 30 may include one or more angled portions. The front wall may include a recess 60, and a first angled portion 40, a second angled portion 42, a third angled portion 44, or a combination thereof within the recess 60. The first angled portion 40 and the second angled portion 42 may form a peak 46.

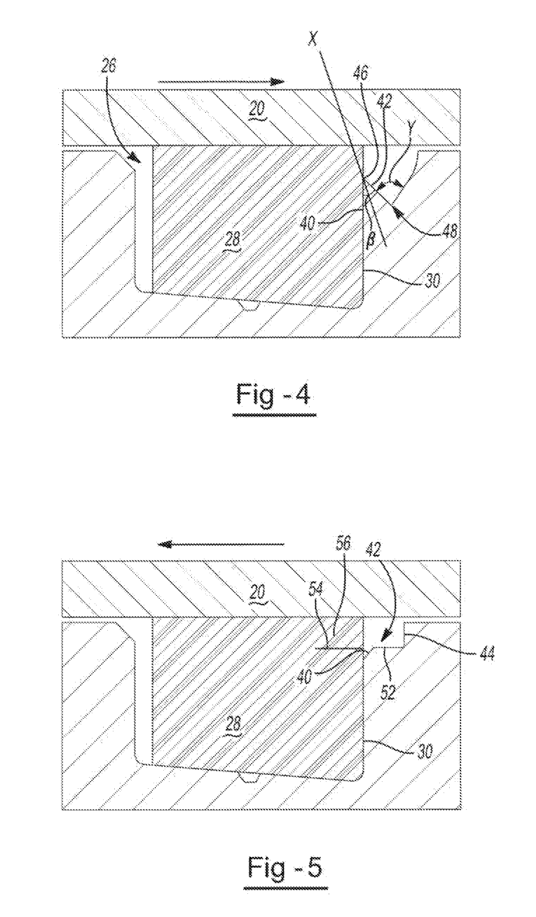

FIGS. 2-5 illustrate different possible angles that may be employed by the present invention. The first angled portion 40 may form any suitable angle (α) to form a peak (i.e. a pivot point). The first angled portion may have a positive slope; however, if the cross section is viewed in the opposite direction they first angled portion may have a negative slope. The first peak may be substantially parallel to the seal and have a slope of 0 degrees as is shown in FIG. 4. The first angle (α) may form an angle about 90 degrees or less, about 75 degrees or less, about 60 degrees or less, about 45 degrees or less, about 30 degrees or less, about 15 degrees or less, or even about 0 degrees. Preferably, the first angle (α) is between about 0 degrees and 75 degrees; more preferably (α) is between about 15 degrees and about 60 degrees (i.e. about 45 degrees).

The second angled portion 42 may form any suitable angle (θ) that forms a peak. The second angled portion may have a negative slope. The second angle (θ) may form an angle about 90 degrees or less, about 75 degrees or less, about 60 degrees or less, about 45 degrees or less, about 30 degrees or less, about 15 degrees or less, or even about 0 degrees. Preferably, the second angle (θ) is between about 0 degrees and 75 degrees; more preferably (θ) is between about 15 degrees and about 60 degrees (i.e. about 60 degrees).

The first angle (α) and second angle (θ) may form an angle (β), which represents the angle of the peak. The peak angle (β) may be about 15 degrees or more, about 30 degrees or more, about 45 degrees or more, about 60 degrees or more, about 75 degrees or more, or even about 105 degrees or more. The peak angle (β) may be between about 15 degrees to about 135 degrees, between about 30 degrees and about 115 degrees, between about 45 degrees and about 105 degrees, or between about 45 and about 75 degrees.

The front wall 30 and/or piston bore 14 may further include an expansion chamber 48 (i.e. a portion where material has been removed) located axially further from the front wall than the peak. The expansion chamber may be of any size or configuration so that a peak is formed and the seal may be cut. For example, the expansion chamber 48 may be rounded, angled, a reverse mirror image of the peak, an extension of the second wall of the peak, or a combination thereof.

As illustrated in FIG. 2, the expansion chamber 48 may be rounded. The rounded portion will include a radius (r). The radius may be about 0.1 mm or more, about 0.2 mm or more, about 0.3 mm or more, about 0.4 mm or more, or even about 0.5 mm or more. The second angled portion and the third angled portion may not contact each other. The rounded portion may be located in-between the second angled portion and the third angled portion. Preferably, if the caliper body includes a third angled portion; the third angled portion will have a positive slope (i.e. rise/run where both rise and run are positive).

As is illustrated in FIGS. 3-5, the expansion chamber 48 may not be rounded. The second angled portion 42 and the third angled portion 44 may form the expansion chamber 48 and the expansion chamber may include an angle (γ). The angle (γ) of the recess may be about 90 degrees or less, about 60 degrees or less, about 45 degrees or less, about 30 degrees or less, or even about 15 degrees or less. However, it is contemplated that the caliper body 6 may be free of a third angled portion as is illustrated in FIG. 3.

FIGS. 3-5 illustrate that the at least one piston 20 may contact the seal 28. Preferably, the piston and the seal form an interference fit so that fluid does not pass the seal when pressure is applied to the piston (i.e. brake apply). FIG. 4 illustrates a seal 28 located in the annular seal groove 26 before any brake pressure has been applied to the piston (i.e. the seal has not been cut). As is illustrated in FIG. 4, when a brake pressure is applied the piston travels towards the front wall in the direction of the arrow (i.e. apply direction). The fluid pressure and/or piston pulls and/or pushes the seal into contact with the peak 46, where the peak cuts the seal. When the brake pressure is released the piston may begin to move towards the back wall (i.e. retract direction) as indicated by an arrow in FIG. 5. The piston may retract without any help from the seal. The piston may retract with assistance from the seal. The cut seal may substantially assist the piston in retracting.

FIGS. 3 and 5 illustrate two possible configurations where the seal has been cut. The seal may have a height (H). FIG. 3 illustrates one possible configuration of a peak and an example of one cut that may be made using a peak. FIG. 5 illustrates a configuration that may be used with a pre-cut seal and the shape of the cut in the pre-cut seal. The height of the seal may be about 2.25 mm or more, about 2.5 mm or more, about 2.75 mm or more, about 3.0 cm or more, or even about 3.25 cm or more (e.g. between about 3.0 mm and about 3.5 mm). The seal may be cut at any location along the height of the seal. The cut in the seal may be located at about ½, about ⅔, about a ¾, or even about ⅞ height distance from the bottom 34 of the seal groove to piston interface. The width of the cut may vary (i.e. the cut may be diagonal, sinusoidal, or the like). Preferably, the cut will have a substantially equal height at any position around the seal. When the seal cuts itself in the caliper, the cross-sectional cut shape may be any shape.

The seal may have a width (W). The width of the seal may be, about 0.5 mm or more, about 1.0 mm or more, about 2.0 mm or more, about 3.0 mm or more, or even about 3.5 mm or more.

The seal may include a cut 54. The cut 54 in the seal may have a depth (D). The depth of the cut may penetrate into the seal about ¾ or less, about ½ or less, about ¼ or less, or even about ⅛ or less. The depth of the cut may vary across the width of the profile (e.g. one side may be cut about ¼ of the way through and the other side may be cut about ⅜ of the way through). The depth of the cut may about 1.5 mm or less, about 1.2 mm or less, about 1.0 mm or less, about 0.8 mm or less, or even about 0.5 mm or less. The depth (D) of the cut may be ratio of the total width (W) of the seal. The ratio of depth of the cut to total width of the seal may have a ratio of between about 1:2 to about 1:5, between about 1:2.5 to about 1:4, or between about 1:3, to about 1:3.5. The cut in the seal may create a cut portion 56 (i.e. a smaller portion of the seal that is separated from the seal body by a cut). The cut portion 56 may travel around the peak once the seal has been cut by the peak.

The peak may be located any distance from the front wall. The peak may be located at the front wall (i.e. the front wall is the first angled portion of the peak). The peak may be located axially from the front wall a length (L). The length (L) that the peak is located from the front.wall may vary the depth (D) of the out in the seal. For example, as the length (L) becomes smaller the depth (D) of the cut may become larger with the same amount of pressure applied to the piston.

FIG. 4 illustrates one possible attitude of the peak 46. The attitude of the peak may be illustrated by line X, which shows the direction the peak is skewed and/or angled in relationship to the seal. The attitude of the peak as illustrated in FIG. 4 has an attitude with a negative slope (i.e. pointing in the retract direction). The first angled portion 40 is the front wall 30 so that the angle of the first angled portion is the same as the front wall.

FIG. 5 illustrates an example with a first angled portion 40, a second angled portion 42 that forms a shelf 52, and a third angled portion 44, which is substantially parallel to the front wall of the annular groove. In an embodiment including a pre-cut seal the brake may be free of a peak. In an embodiment including a pre-cut seal the brake may be free of an expansion chamber.

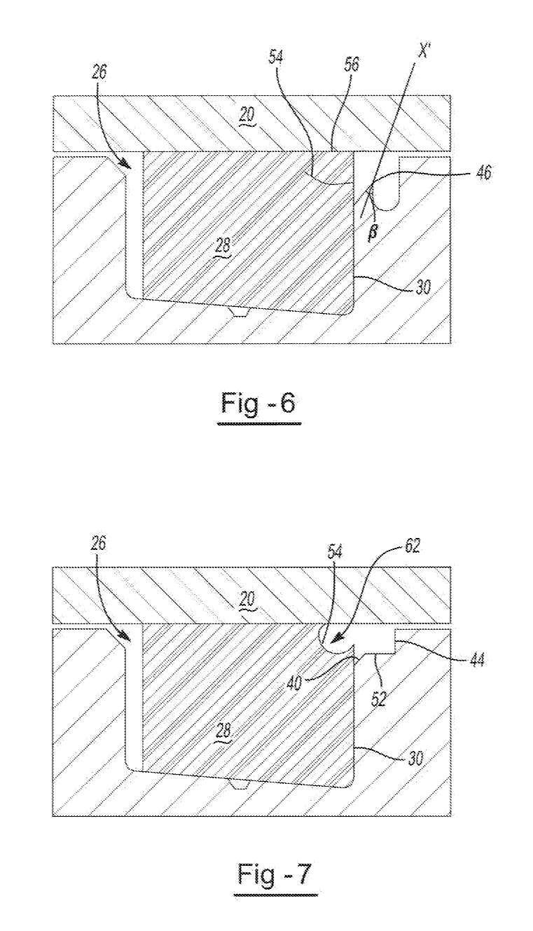

FIG. 6 illustrates an example of the present invention with a first angled portion 40 and a second angled portion 42 that form a peak 46. The peak 46 includes an attitude. The attitude of the peak is illustrated using line X′. The line X′ bisects the angle (B) between the first angled portion 40 and the second angled portion 42 and passes through peak 46, and illustrates the direction the peak is skewed and/or angled in relationship to the seal. The slope of the line X′ can be compared with line X as illustrated in FIG. 4, which shows another attitude of a peak. The attitude of the peak as illustrated in FIG. 6 has an attitude with a positive slope (i.e. pointing in the apply direction).

FIG. 7 illustrates another possible example of the present invention showing a seal where a portion of the seal has been removed. It is contemplated that the seal may be pre-cut and a portion of the seal 28 may be removed (i.e. removed portion 62) before the seal is placed into the annular seal groove 26. The seal 28 with the cut 54 may then be placed in the annular groove 26 so that the cut 54 is oriented in proximity to the front wall 30. The cut 54 in the seal may be moved towards the first angled portion 40 as the piston 20 travels in the apply direction. The cut 54 may be pushed and/or pulled so that a portion of the seal 28 contacts the shelf 52. The seal 28 during a brake apply may not contact the third angled portion 44 due to the removed portion 62. The seal 28 during a brake apply may contact the third angled portion 44 due to the removed portion 62.

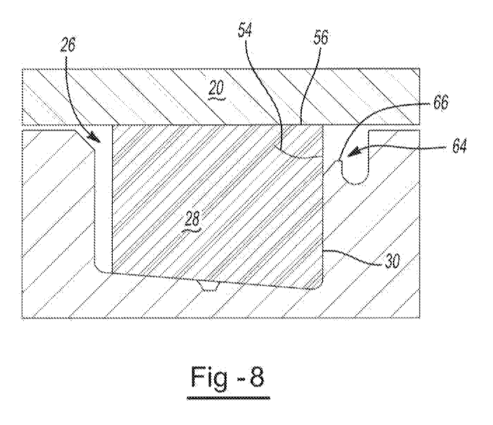

FIG. 8 illustrates one possible example of the present invention showing a recess 60 that includes a blunt peak 64 that is formed when the first angled wall 40 and the second angled wall 42 converge at a blunt wall 66. The blunt peak 64 cuts the seal 28 and creates a cut portion 56 above the cut 54. The blunt wall 66 is substantially perpendicular to the front wall 30.

According to one aspect of the invention, there is disclosed a brake system, seal, a seal groove, and a method of forming the same. The brake system may include a rotor, an inboard brake pad, an outboard brake pad, a support body, and a caliper body. The caliper body may include at least one piston, a finger portion, a cylinder portion, a bridge portion, and a seal.' The cylinder portion may include an annular expansion chamber, which houses the at least one piston. The bridge portion may connect the outboard finger portion and the cylinder portion. The seal may be located at least partially in the at least one annular expansion chamber, and in contact with the at least one piston as the at least one piston slides substantially axially towards the rotor. The annular groove (i.e. annular recess) may include one or more angled portions (e.g. one angle, two angles, three angles, or four angles). The brake system may include an air gap (i.e. running clearance). The brake may have a pre-brake apply air gap and/or post-brake apply air gap. The at least one piston may contact either the inboard brake pad or the outboard brake pad. The at least one piston may move the inboard brake pad or outboard brake pad into contact with the rotor. The inboard brake pad, outboard brake pad, or both may move substantially axially in relation to the rotor. The inboard brake pad, the outboard brake pad, or both may be contacted by the at least one piston. The inboard brake pad, the outboard brake pad, or both may be contacted by the at least one piston and the caliper may travel so that the other brake pad moves it into contact with the rotor. The seal may be cut and placed in any of the seal grooves disclosed herein. The seal may be placed in the seal groove and then be cut by the seal groove when the brake is applied.

In another possible embodiment, the first edge and the second edge may form an angle between about 15 and about 110 degrees, the first edge and the second edge may form an angle between about 30 and about 60 degrees. The seal groove may include a expansion chamber, and the expansion chamber may have a radius of more than about 0.2 mm. An air gap (i.e. running clearance) may be formed when the piston travels away from the forward wall during brake retract. The piston may substantially return to the same position, maintaining air gap after braking regardless of the amount of pressure applied to the brake. The peak may cut the seal during a pressure apply and the at least one angled portion is substantially axially located farther from the forward wall so that the depth of the cut is shallow. The peak may cut the seat during a pressure apply and the at least one angled portion is substantially axially located closer to the forward wall so that the depth of the cut is deep. Piston slip may occur at lower pressures the closer the at least one angled portion is substantially axially located to the forward wall. Piston slip may occur at higher pressures the further the at least one angled portion is substantially axially located from the forward wall. The annular recess may include an angled portion that forms a shelf. The expansion chamber may be located axially past the angled portion in the apply direction. The annular recess may include a rounded portion between the second angled portion and the third angled portion. The cut in the seal may be in the top half of the seal. The cut in the seal may be arcuate, substantially parallel to the axis of the piston, less than half way through the seal in the axial direction in relationship to the rotor, and cut may be less than a quarter of the way through the seal in the axial direction in relationship to the rotor. The presence of a cut in the seal may not reduce its effectiveness to resist fluid leakage. The seal may assist in retracting the piston after the piston has traveled axially towards the rotor and the piston may return to substantially the same starting position as the piston was in before the piston traveled axially towards the rotor.

In another possible embodiment, a brake system may include one or more of the following: a seal groove including a rounded portion; a expansion chamber that has a radius of more than about 0.2 mm; an air gap is formed when the piston travels away from the forward wall; or a piston substantially returning to the same position. The brake system may maintain a constant air gap after braking regardless of the amount of pressure applied to the brake; a peak cutting the seal during a pressure apply and the at least one angled portion is substantially axially located farther from the forward wall so that the depth of the cut is shallow; a peak cutting the seal during a pressure apply and the at least one angled portion is substantially axially located closer from the forward wall so that the depth of the cut is deep; wherein piston slip occurs at lower pressures the closer the at least one angled portion is substantially axially located from the forward wall; or wherein the further the at least one angled portion is substantially axially located from the forward wall, so that piston slip occurs at higher pressures.

In yet another possible embodiment, the brake system may be created using one or more steps of the method including: obtaining a seal; applying fluid pressure to a brake; cutting the seal with a sharp edge; wherein the fluid pushes against a piston; wherein the piston bore includes a seal groove and a seal; wherein the seal groove includes a peak and the piston forces the seal into contact with the peak so that the peak cuts the seal. The method of creating a cut seal may further include one or more of the following steps: a seal groove including a forward wall and a rear wall, and the piston is capable of traveling substantially axially towards and away from the forward wall and the rear wall, and wherein the seal is either cut or precut; a forward wall has at least one angled portion; at least one angled portion forms a peak that has a first edge and a second edge; a first edge having a positive slope, and a second edge having a negative slope; a braking force being applied the piston travels substantially in the axial direction toward the forward wall forcing the seal into contact with the peak, wherein the peak cuts the seal; the first edge and the second edge form an angle between about 15 and about 110 degrees; and a first edge and a second edge forming an angle between about 30 and about 60 degrees.

The front wall may be free of a curved portion and preferably may be free of a convexly curved portion when viewed from the cross section. The front wall may not form an S-Shape when viewed from the cross section. The front wall may be free of an S-Shaped contour when viewed from the cross section. The first angled portion, second angled portion, third angled portion, or a combination thereof may be free of a convexly curved portion. The third angled portion may not form a right angle with the piston. The third angled portion may be free of a right angle portion relative to the piston. The seal that includes a removed portion may be used in conjunction with a annular groove that includes a chamfer, a peak, one or more angled walls, a shelf, an expansion chamber, or a combination thereof. The removed portions may not provide a space for the seal to deflect into before encountering the front wall. The seal may be free of a deflection into the removed portions during a brake apply. The removed portion of the seal may be free of contact with the front wall of the annular groove.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “'x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between' the endpoints. The use of “about” or “approximately” in connection with a range applies to both ends of the range. Thus, “about 20 to 30” is intended to cover “about 20 to about 30”, inclusive of atleast the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A seal groove comprising:
a. a back wall;
b. a front wall opposed to the back wall;
c. a bottom wall connected to the front wall and the back wall; and
d. a recess in the front wall connecting the front wall to the piston bore;
wherein the recess includes a peak which comprises:
i. a first angled portion and
ii. a second angled portion.

2. The seal groove of claim 1, wherein a pre-cut or cutable seal is located inside the seal groove.

3. The seal groove of claim 1, wherein the first angled potion has a positive slope, and the second angled portion has a negative slope.

4. The seal groove of claim 3, wherein the first angled portion is the front wall.

5. The seal groove of claim 1, wherein the first angled portion and the second angled portion form an angle between about 15 and about 110 degrees.

6. The seal groove of claim 1, wherein the recess includes an expansion chamber.

7. The seal groove of claim 6, wherein the expansion chamber has a radius of more than about 0.2 mm.

8. The seal groove of claim 1, wherein the piston substantially returns to the same position, maintaining an air gap, after a pressure apply regardless of the amount of pressure applied.

9. The seal groove of claim 1, wherein the peak cuts the seal during a pressure apply and the depth of the cut varies based upon the length the peak is located from the front wall.

10. The seal groove of claim 1, wherein upon applying a braking pressure, the braking pressure moves a piston located in the piston bore axially toward the forward wall so that the seal is forced into contact with the peak adjacent to the front wall of the seal groove, cutting the seal.

11. The seal groove of claim 2, wherein the cut in the seal is in the top half of the portion of the seal closest to the piston.

12. The disc brake system of claim 2, wherein the presence of the cut in the seal does not reduce its effectiveness to resist fluid leakage.

13. The seal groove of claim 2, wherein the seal assists in retracting the piston to substantially the same position after the piston has traveled axially towards the rotor.

14. The seal groove of claim 1, wherein a seal with a removed portion is located inside the seal groove.

15. A method of cutting a seal comprising:
obtaining a seal;
cutting the seal with a peak,
wherein the piston bore includes a seal groove and a seal,
wherein the seal groove includes a peak and the piston forces the seal into contact with the peak so that the peak cuts the seal.

16. The method of claim 15, wherein the seal groove includes a front wall and a rear wall, and the piston travels substantially axially towards the front wall during a brake apply and substantially axially away from the front wall during a brake retract, and wherein the seal is cut.

17. The method of claim 16, wherein the front wall has at least one angled portion and the at least one angled portion forms a peak that has a first edge and a second edge.

18. The method of claim 16, wherein the first edge has a positive slope, and the second edge has a negative slope.

19. The method of claim 16, wherein upon a braking force being applied the piston travels substantially in the axial direction toward the front wall forcing the seal into contact with the peak, cutting the seal.

20. The method of claim 16, wherein the first edge and the second edge form an angle between about 15 and about 110 degrees.
